(19) United States
(12) Patent Application Publication
(10) Pub. No.: US 2012/0121361 A1
(43) Pub. Date: May 17, 2012

(54) LOOSE PREVENTING ASSEMBLY

(75) Inventors: Kwan Ho LEE, Seoul (KR); Kyu Bum HAN, Gyunggi-do (KR); Young Ho SOHN, Gyunggi-do (KR); Seog Moon CHOI, Seoul (KR)

(73) Assignee: SAMSUNG ELECTRO-MECHANICS CO., LTD., Gyunggi-do (KR)

(21) Appl. No.: 13/091,058

(22) Filed: Apr. 20, 2011

(30) Foreign Application Priority Data
Nov. 11, 2010 (KR) 10-2010-0112283

(51) Int. Cl. F16B 39/04

(52) U.S. Cl. 411/221

(57) ABSTRACT

Disclosed herein is a loose preventing assembly including a bolt, a fastening member, and a pin-spring washer coupled between the bolt and the fastening member. The pin-spring washer includes a spring washer portion, a curved portion of which one end is connected to the spring washer portion to be curved upward and the other end is positioned in an inward direction of the spring washer portion, and a pin portion which extends in one direction from the other end of the curved portion tightens the bolt to couple the pin portion to an insertion groove formed in the bolt, thereby preventing the bolt and the fastening member from being loosened from each other.

### CROSS REFERENCE TO RELATED APPLICATION

This application claims the benefit of Korean Patent Application No. 10-2010-0112283, filed on Nov. 11, 2010, entitled “LOOSE PREVENTING ASSEMBLY”, which is hereby incorporated by reference in its entirety into this application.

### BACKGROUND OF THE INVENTION

1. Technical Field

The present invention relates to a loose preventing assembly.

2. Description of the Related Art

Bolts and nuts are generally used in order to firmly fastening architectural structures, mechanical parts, and the like.

Since tightening bolt and nut assemblies is loosened by external vibration or shock as time elapses, stability of the mechanical parts and the like is deteriorated. In particular, in the case of a printed circuit board, a structure to ground circuit wirings and chasses (alternatively, plates) by using screws is generally used for grounding and when the screw is loosened at the time of using a product, the product is not grounded to be actuated.

Accordingly, in order to prevent the screw from being loosened by the external vibration or shock, auxiliary fastening means such as a flat washer, a spring washer, and the like is used or an additional work using welding or an adhesive agent is performed.

The auxiliary fastening means, the spring washer receives tensioning force in a direction to increase friction force of a thread as being tightened to prevent the bolt from being loosened. However, the tensioning force of the spring washer is deteriorated as time elapses. Further, there is a limit that the screw cannot be completely prevented from being loosened by strong external shock. Besides, since an additional work is required in the case of using the welding or adhesive agent, time and cost are consumed.

### SUMMARY OF THE INVENTION

The present invention has been made in an effort to firmly fasten a bolt and a fastening member to each other without using welding or an adhesive agent by coupling a pin portion of a pin-spring washer to an insertion groove formed at a bolt as the bolt is fastened by using the bolt, the fastening member, and the pin-spring washer coupled between the bolt and the fastening member.

A preferred embodiment of the present invention provides a loose preventing assembly including: a bolt including a head part and a body part vertically coupled to the head part and including an insertion groove which extends in one direction; a fastening member including a hole to which the bolt is screw-coupled; and a pin-spring washer including a spring washer portion coupled between the bolt and the fastening member, a curved portion of which one end is connected to the spring washer portion to be curved upward and the other end is positioned in an inward direction of the spring washer portion, and a pin portion which extends in one direction from the other end of the curved portion.

Herein, the bolt may include the plurality of insertion grooves formed in the body part.

The width of the insertion groove of the bolt may correspond to the pin portion so as to insert the pin portion of the pin-spring washer.

In addition, a groove corresponding to the pin portion may be formed on in an inner surface of the hole which is in contact with the bolt so that the pin portion is positioned in the hole formed in the fastening member when the pin-spring washer is coupled to the bolt and inserted into the hole.

The spring washer portion of the pin-spring washer may include a plurality of protrusions formed on the inner surface which is in contact with the bolt by being coupled with the bolt.

The length of the pin portion of the pin-spring washer may correspond to the length of the insertion groove of the bolt.

A cross section of the pin portion of the pin-spring washer may have any one of a circular shape, a triangular shape, a quadrangular shape, and a trapezoidal shape.

The pin-spring washer may be made of an elastic material.

The elastic material may be any one of spring steel, stainless steel, and polycarbonate.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Various objects, advantages and features of the invention will become apparent from the following description of embodiments with reference to the accompanying drawings

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

### BRIEF DESCRIPTION OF THE DRAWINGS

FIG. 1 is a perspective view of a loose preventing assembly according to a first preferred embodiment of the present invention;

FIG. 2 is a perspective view of a bolt according to a preferred embodiment of the present invention;

FIG. 3 is a perspective view of a loose preventing assembly and a fastening member according to a second preferred embodiment of the present invention; and

FIGS. 4 to 7 are perspective views of a pin-spring washer according to a preferred embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

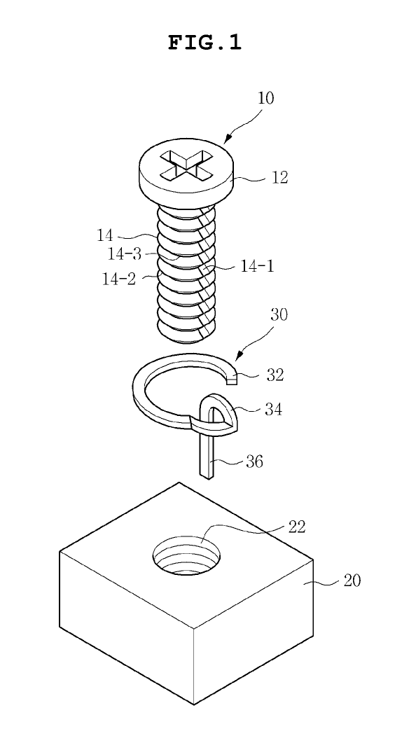

First, referring to FIG. 1, a loose preventing assembly will be described. The loose preventing assembly includes a bolt 10, a fastening member 20, and a pin-spring washer 30. In detail, the bolt 10 is constituted by a head part 12 and a body part 14 vertically coupled to the head part 12 and including an insertion groove 14-1 formed in one direction and the fastening member 20 includes a hole 22 to which the bolt 10 is screw-coupled. The pin-spring washer 30 is coupled between the bolt 10 and the fastening member 20 and includes a spring washer portion 32, a curved portion 34 of which one end is connected to the spring washer portion 32 to be curved upward and the other end is positioned in an inward direction of the spring washer portion 32, and a pin portion 36 that extends in one direction from the other end of the curved portion 34.

In an assembling process of the loose preventing assembly, the pin-spring washer 30 is firstly coupled to the bolt 10 and inserted into the hole 22 of the fastening member 20 and thereafter, the head part 12 of the bolt 10 presses the curved portion 34 of the pin-spring washer 30 as the bolt 10 is tightened, such that the pin portion 36 connected to the other end of the curved portion 34 moves in the inward direction. In this case, the pin portion 36 is inserted into and fastened to the insertion groove 14-1 of the bolt 10 and the bolt 10 is thus screw-coupled to the fastening member 20 to be prevented from being loosened.

Hereinafter, the loose preventing assembly will be described for each of components thereof.

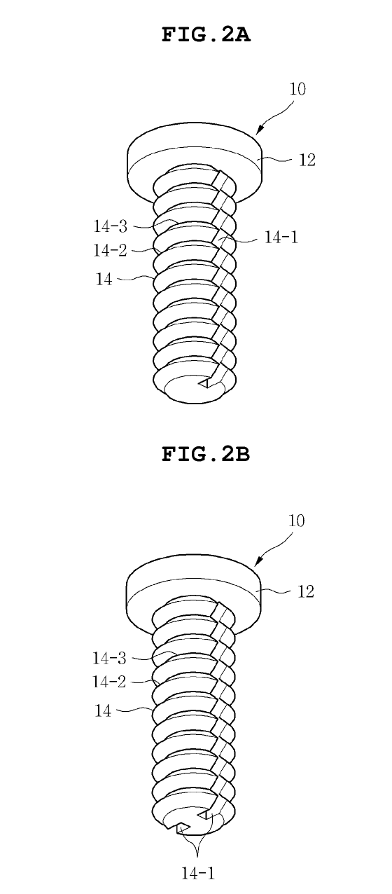

As shown in FIG. 2A, the bolt 10 is constituted by the head part 12 and the body part 14 including the insertion groove 14-1 that is formed in one direction. The body part 14 is screw-coupled to the fastening member 20. A portion which is protruded outwardly from the surface of the body part 14 is called a ‘thread’ 14-2 and a portion which is hollow inside of the surface is called a ‘spiral groove’ 14-3. A ‘pitch’ is called a distance between the thread 14-2 and the spiral groove 14-3 of the bolt 10. As the pitch is smaller, an interval between the threads is smaller and coupling force is stronger. The insertion groove 14-1 formed in the body part 14 extends in one direction, which is not limited to a straight direction vertical to the head part 12 shown in FIG. 2A and includes a diagonal direction, and the like.

The width of the insertion groove 14-1 formed in the bolt 10 preferably corresponds to the pin portion 36 of the pin-spring washer 30. The pin portion 36 is inserted into and coupled to the insertion groove 14-1 of the bolt 10 to prevent the bolt 10 from rotating in a loosing direction, as a result, the pin portion 36 should be easily inserted into the insertion groove 14-1 and the pin portion 36 should not be pulled out again after the coupling. Accordingly, the width of the insertion groove 14-1 corresponds to the pin portion 36, which is easily inserted and after the pin portion 36 is coupled to the insertion groove 14-1, such that there is no spare space in the insertion groove 14-1, thereby increasing a coupling strength.

Further, as shown in FIG. 2B, the bolt 10 may include a plurality of insertion grooves 14-1 in the body part 14. Since the pin portion 36 may be coupled to each of the plurality of insertion grooves 14-1 formed in the body part 14, it is not necessary to excessively tighten the bolt 10 so as to locate the insertion groove 14-1 of the body part 14 at the pin portion 36.

The fastening member 20 includes a screw-coupled hole 22 and the bolt 10 and the pin-spring washer 30 are coupled to the fastening member 20. The fastening member 20 may be a nut, but is not limited thereto and includes all members that include the screw-coupled hole 22 formed by drilling, such as a metal plate, a circuit board, and the like.

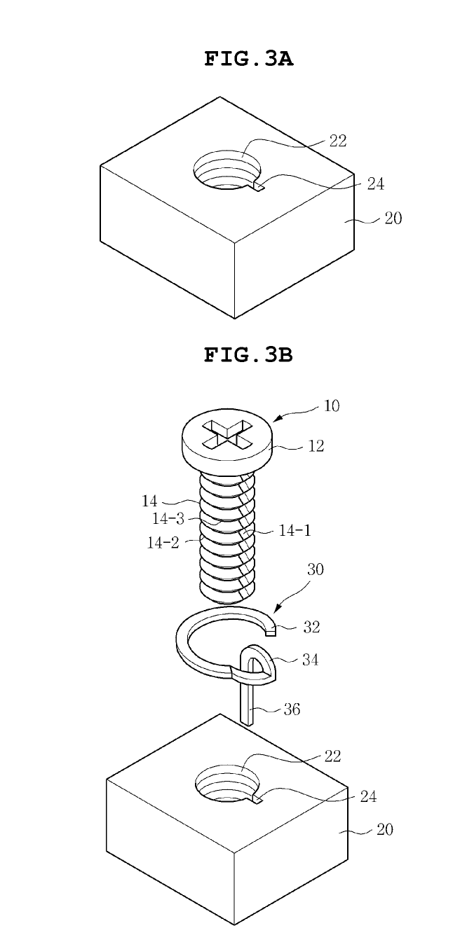

In this case, preferably, as shown in FIG. 3A, when the pin-spring washer 30 which is coupled to the bolt 10 is inserted into the hole 22 formed in the fastening member 20, a groove 24 corresponding to the pin portion 36 is provided on the inner surface of the hole 22 so as to locate the pin portion 36. As shown in FIG. 3B, the groove 24 in which the pin portion 36 is positioned is formed on the inner surface of the hole 22, such that the bolt 10 and the pin-spring washer 30 may be easily inserted into the hole 22. Further, since the pin portion 36 is positioned in the groove 24 formed in the hole 22 when the pin-spring washer 30 is inserted into the fastening member 20, the hole 22 does not need to be formed by considering the size of the pin portion 36 and the diameter of the hole 22 may correspond to the diameter of the bolt 10. As a result, the dimension of the bolt 10 screw-coupled to the inner surface of the hole 22 increases to increase friction force, thereby more firmly preventing the bolt 10 from being loosened.

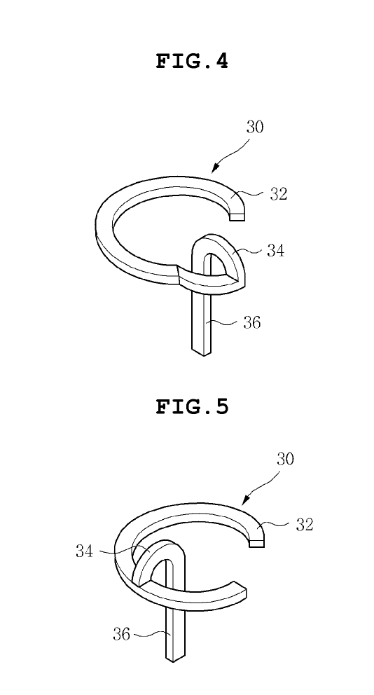

The pin-spring washer 30 is constituted by the spring washer 32, the curved portion 34, and the pin portion 36 as shown in FIG. 4.

The spring washer portion 32 tightens the bolt 10 in a twisted coil form to press the spring washer portion 32, such that the tensioning force is applied to the bolt 10 in a direction to increase the friction force of the thread 14-2 to prevent the bolt 10 from being loosened.

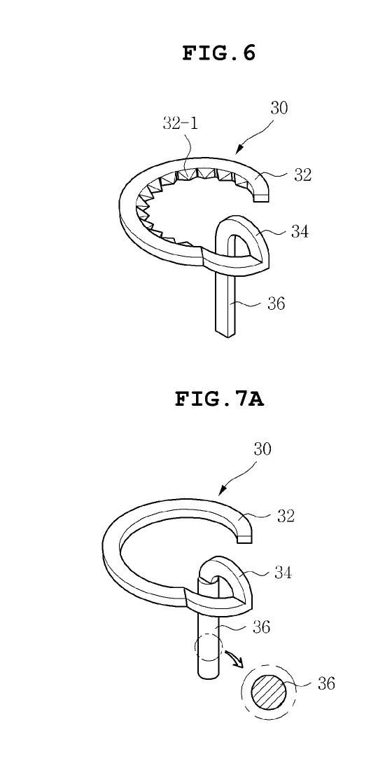

In this case, preferably, the spring washer portion 32 includes a plurality of protrusions 32-1 on an inner surface thereof which is in contact with the bolt by being coupled with the bolt 10 as shown in FIG. 6. The plurality of protrusions 32-1 are formed on the inner surface of the spring washer portion 32 at a regular interval and may have various shapes including a quadrangular shape, a triangular shape, and the like. The plurality of protrusions 32-1 are suspended to the spiral groove 14-3 of the bolt 10 to increase the friction force, thereby preventing the bolt 10 from rotating in the loosing direction.

One end of the curved portion 34 is connected to the spring washer portion 32 to be curved upward and the other end of the curved portion 34 is positioned in the inward direction of the spring washer portion 32. The length of the curved portion 34 should be sufficient so that the pin portion 36 connected to the other end thereof is coupled to the insertion groove 14-1 of the bolt 10 while the head part 12 of the bolt 10 presses the curved portion 34 of which a curve is gently straightened.

By adjusting a curvature of the curved portion 34, it is possible to change the coupling strength of the pin portion 36 to the insertion groove 14-1 of the bolt 10. In the case where the curvature is large, since a force to push the pin portion 36 to the insertion groove 14-1 increases as the bolt 10 is tightened, the coupling strength increases. The curved portion 34 may be connected to any part of the spring washer portion 32 as shown in FIG. 5. However, the curved portion 34 is preferably connected to one end of the spring washer portion 32 so that the spring washer portion 32 effectively applies the tensioning force to the bolt 10 by surrounding the circumference of the bolt 10.

The pin portion 36 extends in one direction from the other end of the curved portion 34. The length of the pin portion 36 preferably corresponds to the length of the insertion groove 14-1. As the length of the pin portion 36 inserted into and coupled to the insertion groove 14-1 increases, a resistance force to the rotation of the bolt 10 in the loosing direction increases, thereby more firmly preventing the bolt 10 from being loosened.

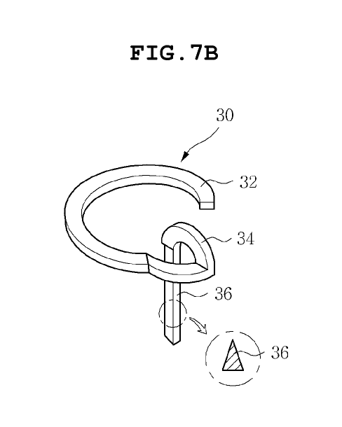

Further, a cross section of the pin portion 36 may have any one of a circular shape (FIG. 7A), a triangular shape (FIG. 7B), a quadrangular shape, and a trapezoidal shape. The cross section is not limited to the shapes shown in the figure and may have various other shapes.

In this case, the pin-spring washer 30 is preferably made of an elastic material. The pin-spring washer 30 is made of the elastic material, such that the pin portion 36 is coupled to the insertion groove 14-1 while the bolt 10 presses the curved portion 34 of which the curve is easily and gently straightened and in addition, the tensioning force to which the spring washer portion 32 applies to the bolt 10 increases to firmly prevent the bolt 10 from being loosened.

The pin-spring washer 30 may be made of any one of spring steel, stainless steel, and polycarbonate as the elastic material. However, the pin-spring washer 30 is not limited thereto and may be made of all materials having a large strength.

According to preferred embodiments of the present invention, a loose preventing assembly includes a bolt, a fastening member, and a pin-spring washer coupled between the bolt and the fastening member and a curved portion of the pin-spring washer is pressed by tightening the bolt to couple a pin portion to an insertion groove formed at the bolt, thereby preventing the bolt from being loosened.

Further, according to the preferred embodiments of the present invention, a plurality of insertion grooves are provided in a body part to easily couple the pin portion to the insertion groove at the time of tightening the bolt.

In addition, according to the preferred embodiments of the present invention, the length of the pin portion corresponds to the length of the insertion groove, such that the pin portion is coupled to the entire inner part of the insertion groove, thereby improving the coupling strength of the pin portion.

According to the preferred embodiments of the present invention, a plurality of protrusions are formed on an inner surface of the spring washer which is in contact with the bolt to be suspended to a thread, thereby preventing the bolt from rotating in a loosing direction.

According to the preferred embodiments of the present invention, a groove corresponding to the pin portion is formed on the inner surface of a hole formed in the fastening member and the pin-spring washer is coupled to the bolt to be easily inserted into and screw-coupled to the fastening member.

According to the preferred embodiments of the present invention, the pin-spring washer is made of an elastic material to increase tensioning force applied to the bolt, thereby effectively preventing the bolt from rotating in the loosing direction.

Although the preferred embodiments of the present invention have been disclosed for illustrative purposes, they are for specifically explaining the present invention and thus a loose preventing assembly according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A loose preventing assembly, comprising:
a bolt including a head part and a body part vertically coupled to the head part and including an insertion groove which extends in one direction;
a fastening member including a hole to which the bolt is screw-coupled; and
a pin-spring washer including a spring washer portion coupled between the bolt and the fastening member, a curved portion of which one end is connected to the spring washer portion to be curved upward and the other end is positioned in an inward direction of the spring washer portion, and a pin portion which extends in one direction from the other end of the curved portion.

2. The loose preventing assembly as set forth in claim 1, wherein the bolt includes the plurality of insertion grooves formed in the body part.

3. The loose preventing assembly as set forth in claim 1, wherein the width of the insertion groove of the bolt corresponds to the pin portion so as to insert the pin portion of the pin-spring washer.

4. The loose preventing assembly as set forth in claim 1, wherein a groove corresponding to the pin portion is formed on in an inner surface of the hole which is in contact with the bolt so that the pin portion is positioned in the hole formed in the fastening member when the pin-spring washer is coupled to the bolt and inserted into the hole.

5. The loose preventing assembly as set forth in claim 1, wherein the spring washer portion of the pin-spring washer includes a plurality of protrusions formed on the inner surface which is in contact with the bolt by being coupled with the bolt

6. The loose preventing assembly as set forth in claim 1, wherein the length of the pin portion of the pin-spring washer corresponds to the length of the insertion groove of the bolt

7. The loose preventing assembly as set forth in claim 1, wherein a cross section of the pin portion of the pin-spring washer has any one of a circular shape, a triangular shape, a quadrangular shape, and a trapezoidal shape.

8. The loose preventing assembly as set forth in claim 1, wherein the pin-spring washer is made of an elastic material.

9. The loose preventing assembly as set forth in claim 8, wherein the elastic material is any one of spring steel, stainless steel, and polycarbonate.
